(19) United States
(12) Patent Application Publication
(10) Pub. No.: US 2010/0302141 A1
(43) Pub. Date: Dec. 2, 2010

(54) Display and Interaction Environment for Mobile Devices

(76) Inventors: Subramonian Shankar, Norcross, GA (US); Subash Kalbarga, Suwanee, GA (US); Sanjoy Maity, Snellville, GA (US); Vinothkumar Sundaramoorthy, Norcross, GA (US); Anbarasu Sethupandian, Norcross, GA (US)

Correspondence Address: Parks IP Law LLC, 1117 PERIMETER CENTER WEST, SUITE E402, ATLANTA, GA, 30338, US

(21) Appl. No.: 12/788,406

(22) Filed: May 27, 2010

Related U.S. Application Data
(60) Provisional application No. 61/181,845, filed on May 28, 2009.

(51) Int. Cl. G09G 5/00

(52) U.S. Cl. 345/156

(57) ABSTRACT

A computing device attached to a full-sized display and one or more user input devices supports a mobile device mating environment. Software modules running on a mobile device may interface with custom firmware or software modules on the computing device to support using the display, keyboard, mouse, and other user input devices of the computing device. The display of the computing device may also be leveraged to display screens and notifications generated by the mobile device. The user input devices of the computing device may be utilized to simplify interaction between the user and the mobile device. This operation may be selected instead of, or in addition to, operating the computing device according to its traditional functions associated with a primary operating system and associated applications of the computing device.

### CROSS-REFERENCE TO RELATED APPLICATIONS

This application claims the benefit of provisional U.S. patent application No. 61/181,845, filed on May 28, 2009, and entitled “Scaled Display and Interaction Environment For Mobile Devices,” which is expressly incorporated by reference herein in its entirety.

### BACKGROUND

Mobile devices, such as mobile telephones, smartphones, personal digital assistants (“PDAs”), and small form-factor mobile computers, typically include very small display screens. Due to their small size, the display screens used on many mobile devices can be difficult for some users to read.

Many mobile devices also include a very small keyboard, which also due to their small size, can be difficult for many users to type upon. Some mobile devices include a touch screen that can be utilized to display a virtual keyboard and to receive user input. It can, however, also be difficult to enter text by way of a small touch screen.

It is with respect to these and other considerations that the disclosure presented herein has been made.

### SUMMARY

The following disclosure is directed to technologies for leveraging large displays and external input devices in association with smart phones and other mobile devices. Networking and interfacing capabilities of smart phones and other mobile devices may be leveraged to access larger displays and better input devices than typically found on mobile devices. Larger displays and better input devices are available ubiquitously in modern environments. For example, computers with monitors and keyboards are scattered throughout workplaces and at homes. Also, televisions with set top boxes, display projectors, and various other display options are widely available. Leveraging these displays and input devices may support the use of smart phones and other mobile devices as processing units for general computing tasks.

According to one aspect presented herein, a phone mating environment may be supported on any computing device attached to a larger display and some human interface devices (“HIDs”). It is not unusual today for a user to carry a mobile phone or other mobile device along with a laptop, notebook, or netbook computer simultaneously. Software modules running on the mobile device may interface with custom firmware or software modules on the computer device to support using the display, keyboard, mouse, and other devices of the computer device. The display of the computer device may be leveraged to display screens and notifications from the mobile phone or other mobile device. The input devices of the computer device may simplify interaction between the user and the mobile device. The mobile device and the computer device may interface over a wireless link (such as WI-FI, BLUETOOTH, optical, radio frequency, or other wireless technology) or over a wired interface (such as USB, FIREWIRE, serial, parallel, or other wired computer interface technology).

Customized firmware and/or software within a computer device, or other host device, may support the rapid connection to a mobile phone or other mobile device. When the computer device is switched on, the user may enter a phone mating environment. The phone mating environment may be made available using an instant-on technology associated with the firmware of the computer device. The phone mating environment may also be made available during regular operation of the computer device.

Within the phone mating environment, the user can immediately chose to perform tasks associated with the mobile device using the full-sized display screen, keyboard, mouse, and other input devices of the computer device. Through such phone mating technology associated with the firmware and or software of the computer device, the user may select to rapidly operate the computer device as an extension of their mobile phone or other mobile device. This operation may be selected instead of, or in addition to, operating the computer device according to its traditional functions associated with the main operating system (“OS”) and associated applications of the computer device.

External displays may also be leveraged by the mobile device intelligently. For instance, according to another aspect, the smaller integrated display of the mobile device screen may not be merely magnified by pixel expansion. Instead, a pseudo display device is provided to applications on the mobile device. The pseudo display can be utilized by applications to scale their output as if a larger display was present. As such, improved quality and legibility of the display may be maintained.

It should be appreciated that the above-described subject matter may also be implemented as a computing system, a computer-controlled apparatus, a computer process, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all of the disadvantages noted in any part of this disclosure.

### BRIEF DESCRIPTION OF THE DRAWINGS

FIG. 1 is a computer network architecture diagram showing aspects of one operating environment and several components provided herein;

FIGS. 2-3 are flow diagrams showing aspects of several embodiments disclosed herein; and

FIG. 4 is a computer architecture diagram showing aspects of one computing system upon which the software components described herein may be executed.

### DETAILED DESCRIPTION

Technologies and concepts are disclosed herein for utilizing large displays and external user input devices in association with smart phones and other types of mobile devices. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following description, references are made to the accompanying drawings that form a part hereof, and which are shown by way of illustration specific embodiments or examples. Referring now to the drawings, in which like numerals represent like elements throughout the several figures, aspects of a scaled display and interaction environment for mobile devices will be described.

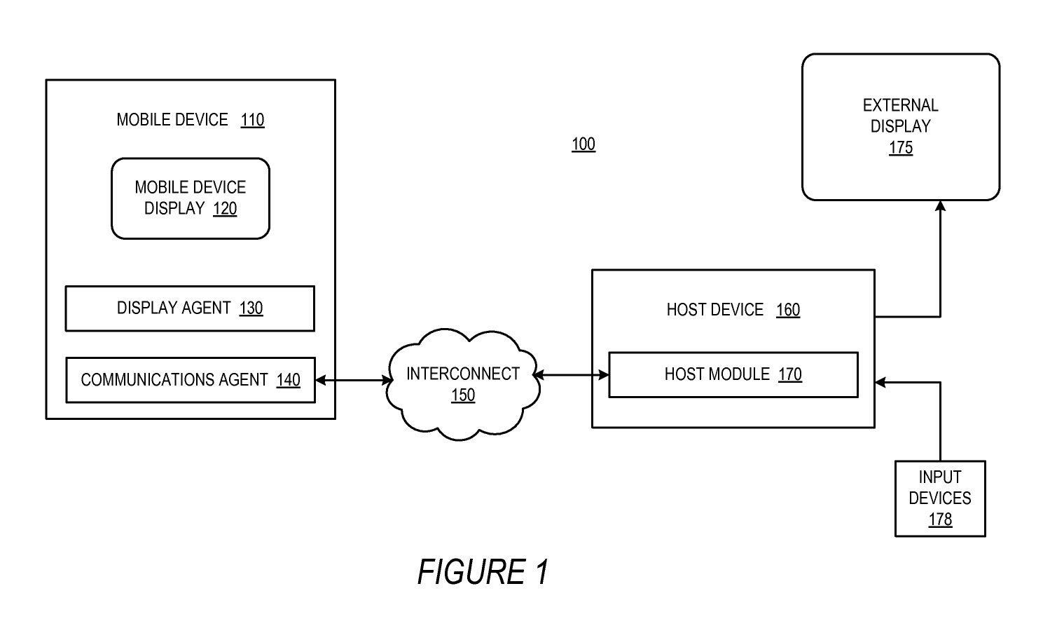

Turning now to FIG. 1, details will be provided regarding an illustrative operating environment and several software components provided by the embodiments presented herein. In particular, FIG. 1 shows a block diagram 100 that illustrates a mobile device 110 interfacing to an external display 175 and input devices 178 through a host device 160 according to one or more embodiments presented herein. While the mobile device 110 may have its own integrated mobile device display 120, various external displays 175 may be used by the mobile device 110 as improved hereby, or possibly larger, output devices. The external display 175 may be a computer monitor, television, a laptop display, a projector, or any other external display.

A display agent 130 may execute on, or in association with, the mobile device 110. The display agent 130 may receive display writes, or screen paints, from an operating system or other software executing on the mobile device 110. The display agent 130 may capture, buffer or otherwise receive display writes associated with the mobile device 110. These display writes may be identical, or similar, to display writes for accessing the integrated mobile device display 120.

According to embodiments, the display exposed to programs executing on the mobile device 110 by the display agent 130 is a larger display than the mobile device display 120. The display exposed to programs executing on the mobile device 110 by the display agent 130 can be written to by applications executing on the mobile device 110 without modifying the applications. According to one aspect, the display exposed by the display agent 130 is presented to the applications as having been changed to a larger area than the mobile device display 120. The applications can then redraw to the larger screen automatically. The inherent property of mobile applications and software to draw on many different kinds of phones with different screen sizes is thereby leveraged.

According to one embodiment, a communications agent 140 may also execute on, or in association with, the mobile device 110. The communications agent 140 may communicate from the mobile device 110 through an interconnect 150 to the host device 160. This communication may be bi-directional and also communicate from the host device 160 back to the mobile device 110. The communications agent 140 may receive the display information from the display agent 130 for delivery through the interconnect 150 to the host device 160. A host module 170 executing on, or in association with, the host device 160 may receive the scaled display information from the communications agent 140 at the mobile device 110. The display information received at the host module 170 within the host device 160 may then be provided to the external display 175. The communications agent 140 may transmit the display information to the host module 170 in an uncompressed or a compressed format. When compression is utilized, an appropriate algorithm may be utilized that reduces the quality of the display information based upon the available bandwidth of the interconnect 150. Hardware compression might also be utilized if appropriate hardware is available on the mobile device 110. Special purpose compression hardware might also be provided for this purpose.

The input devices 178 may provide user input to the host device 160. The user input received at the host device 160 may be processed by the host module 170. The host module 170 may transmit the user input through the interconnect 150 to the communications agent 140 at the mobile device 110. The communication agent 140 may provide the user input received from the host device 160 to operating systems, applications, or other software executing on, or in association with, the mobile device 110. The user input provided to software at the mobile device 110 may be used instead of, or in addition to, input devices integrated into, or directly associated with, the mobile device 110.

The input devices 178 associated with the host device 160 may provide various user interface options, such as full size keyboards, mice, touch screens, light pens, graphics tablets, remote control devices, and so forth. The input devices 178 may also comprise microphones, speakers, headsets, BLUETOOTH headsets, ear buds, earphones, speakerphone modules, and telephone handset modules. These audio input/output devices may be configured such that a microphone at the host device 160 may be directed to the mobile device 110 as a telephone microphone source and telephone audio output from the mobile device 110 may be directed to speakers, or earphones, associated with the host device 160. The various input devices 178 discussed herein may support richer user interface options to the mobile device 110 in comparison to user input devices integrated into, or directly associated with, the mobile device 110.

The mobile device 110 may be a mobile telephone, a smart phone, a personal digital assistant (“PDA”), a small form-factor mobile computer, or any other mobile computing or communications device. Such mobile devices may include small display screens and may include a number of user input devices, such as a small keyboard or a touch screen. The mobile device 110 may support a mobile operating system such as the SYMBIAN OS from SYMBIAN LIMITED, the IPHONE OS from APPLE INC., the RIM BLACKBERRY operating system from RESEARCH IN MOTION, INC., the WINDOWS MOBILE operating system from MICROSOFT, the PALM OS, or the PALM PRE WEBOS developed by PALM, INC., or the ANDROID operating system from GOOGLE, INC.

The host device 160 may be a computer, such as a desktop, laptop, handheld, netbook, or other type of computing system. The host device 160 may also be an embedded computing device serving specifically as an interface to the display 175 and input devices 178 for use by mobile device 110. Such an embedded device may be referred to as a “thin” host.

The host device 160 may also be part of other embedded systems or consumer electronics. For example, the host device 160 may be part of a set-top box associated with a television set which may serve as display 175. According to such an embodiment, the input devices 178 may include a remote control unit associated with the set-top box.

The host device 160 may also be another mobile device 110. The host device 160 may also be a desktop or laptop computer operating in an instant-on mode specifically designed to support displays and interaction for the mobile device 110. Such an instant-on mode, or phone mating mode, may be supported through the firmware, basic input/output system (“BIOS”), legacy BIOS, Extensible Firmware Interface (“EFI”), unified (“UEFI”) firmware, or another type of firmware of the computer device or host device 160.

It should be appreciated that, according to one embodiment, a user of the mobile device 110 can initiate a connection between the mobile device 110 and the host device 160 for displaying the output of the mobile device 110 on the external display 175. According to another implementation, a user of the host device 160 might instantiate the connection. It should also be appreciated that a mechanism might be utilized to mate the mobile device 110 to a particular host device 160 or a set of host devices 160. In such an embodiment, the mobile device 110 might be configured to only send display information to host devices 160 with which it has been mated.

According to another embodiment, a single mobile device 110 might be configured to communicate with multiple host devices 160 concurrently. In this manner, multiple host devices 160 can display data received from the mobile device 110 on multiple external displays 175 simultaneously.

According to other embodiments, display writes, or screen paints, performed by operating systems, software, applications, or other modules executing on, or associated with, the mobile device 110 may use the integrated mobile device display 120 and the external display 175 in a mirrored fashion. For example, a user interface element displayed on the mobile device display 120 may also be displayed on the external display 175. Alternatively, the mobile device display 120 and the external display 175 may be used separately as dual displays to the mobile device 110.

A data path from the mobile device 110 to the host device 160 may be established through the communications agent 140, the interconnect 150, and the host module 170. The data path may support notifications and status signaling bi-directionally between the mobile device 110 and host device 160. The data path may be used to display notifications, status messages, or other information on the external display 175 from the mobile device 110. For example, instant messages, text messages, or phone call information received at the mobile device 110 may appear as pop-ups, dialogs, or other user interface elements on the external display 175.

It should be appreciated that the virtual display mechanism provided herein may utilize various layers of firmware and/or software executing on the mobile device 110 to achieve the same result. For example, one mechanism grabs the contents of the virtual screen presented by the display agent 130 from memory and transmits the bit data to the host device 160. Another mechanism hooks into application programming interface (“API”) calls, such as OpenGL calls, and transmits the details of the API call to the host device 160 where the API call is reinterpreted appropriately. Other mechanisms might also be utilized.

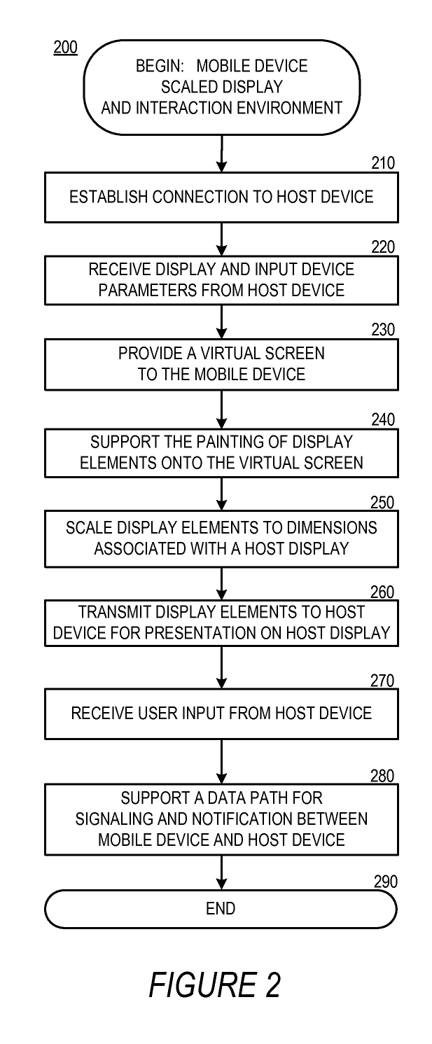

Referring now to FIG. 2, additional details will be provided regarding the embodiments presented herein for supporting scaled displays and interaction environments for mobile devices. In particular, FIG. 2 is a flow diagram illustrating aspects of the operation of a process 200 presented herein for supporting mobile device scaled displays and interaction environments in the manner disclosed herein.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 200 begins at operation 210 where a connection may be established from the mobile device 110 to the host device 160. The connection may use a communications agent 140 associated with the mobile device 110 and a host module 170 associated with the host device 160. The connection between the mobile device 110 and the host device 160 may be over an interconnect 150. The interconnect 150 may comprise a serial or parallel interconnection, a wired or wireless interconnection, a WI-FI interconnection, USB, BLUETOOTH, Ethernet, FIREWIRE, or any other such interconnection between the electronics within the mobile device 110 and the host device 160.

From operation 210 the routine 200 proceeds to operation 220, where configuration information may be received at the mobile device 110. The configuration information may be received from the host device 160 and may provide information concerning the external display 175, such as resolution, screen geometry, color depth, refresh rate, and other operational parameters of the external display 175. The configuration information may also define or provide details regarding the input devices 178, which may include keyboards, mice, light pens, graphics tablets, gesture recognizers, cameras, microphones, touch screens, or any other input devices associated with the host device 160.

From operation 220, the routine 200 proceeds to operation 230 where a virtual screen may be provided within the mobile device. The virtual screen may be provided by the display agent 130 to an operating system, applications, software, or other modules executing on, or in association with, the mobile device 110. The routine 200 then proceeds to operation 240 where the painting of display elements may be supported by the virtual screen provided in operation 230. For example, a virtual screen representing the full geometries of the external display 175 may be presented to an application within the mobile device 110 to allow the application to draw on a virtual screen with display geometries and characteristics appropriate to the external display 175.

At operation 250, the display elements may be pixel scaled to dimensions appropriate to the host display or external display 175. While the integrated mobile device display 120 of the mobile device 110 may be of a smaller or limited geometry, display writes, or screen paints, to the virtual screen may be pixel scaled to support the full geometry of the external display 175. In another embodiment, the display elements are not pixel scaled. Rather, the virtual display presented by the display agent 130 to programs executing on the mobile device 110 is larger than the mobile device display 120. Programs executing on the mobile device 110 can be notified that a larger display device is available for use and, in response thereto, will redraw their screen output to take advantage of the larger display. In this manner, programs executing on the mobile device 110 can utilize the full resolution of the external display 175.

At operation 260, the display elements received at the display agent 130 may be transmitted to the host device 160 for presentation on the external display 175. The display elements may be received by the display agent 130 and communicated by the communications agent 140 over the interconnect 150 to the host module 170 at the host device 160.

At operation 270, user input may be received from the host device 160 at the mobile device 110 for use by the operating system, software, applications, or other modules associated with the mobile device 110. The received user input may originate from input devices 178 associated with the host device 160. The user input may be transmitted over the interconnect 150 to the communications agent 140 for use at the mobile device 110.

At operation 280, a data path may be supported for signaling and notification between the mobile device 110 and the host device 160. The data path may be used for status information or updates between the mobile device 110 and the host device 160. Additionally, telephone or voicemail indicators, text messages, or instant messages received at the mobile device 110 may be provided or notified to the host device 160 for presentation on the external display 175. From operation 280, the routine 200 proceeds to operation 290, where it ends.

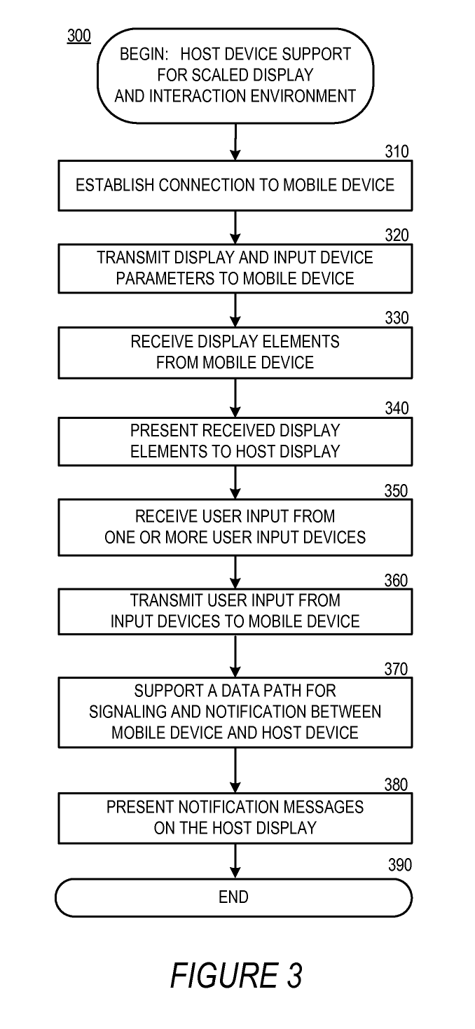

Referring now to FIG. 3, additional details will be provided regarding the embodiments presented herein for supporting external displays and interaction environments for mobile devices. In particular, FIG. 3 is a flow diagram illustrating aspects of the operation of a process 300 presented herein for host device support of scaled displays and interaction environments for mobile devices. The process 300 begins at operation 310 where a connection may be established from the host device 160 to the mobile device 110. The connection may use the interconnect 150 as discussed with respect to operation 210 above.

At operation 320, parameters and configuration information may be transmitted from the host device 160 to the mobile device 110. The parameters and configuration information may relate to display characteristics of the external display 175 and the characteristics of the input devices 178 associated with the host device 160.

At operation 330, display elements may be received from the mobile device 110 into the host device 160 through the host module 170. At operation 340, the received display elements from operation 330 may be presented to a host display device or external display 175. The display elements generated at the mobile device 110 may thus be displayed on the external display 175 for a larger, richer user display experience.

At operation 350, user inputs may be received from one or more input devices 178 into the host device 160. The user inputs may be represented as events or state signals from the input devices 178. At operation 360, user inputs from the input devices 178 may be transmitted from the host device 160 to the mobile device 110 over the interconnect 150 for delivery to the mobile device 110. The input devices 178 may thus be used as inputs to the mobile device 110.

At operation 370, a data path may be supported for signaling and notification between the mobile device 110 and the host device 160. The data path may be used for status information or updates between the mobile device 110 and the host device 160. Additionally, telephone or voicemail indicators, text messages, or instant messages received at the mobile device 110 may be provided or notified to the host device 160 for presentation on the external display 175. At operation 380, notification messages received at operation 370 may be presented to the host display or external display 175. From operation 380, the routine 300 proceeds to operation 390, where it ends.

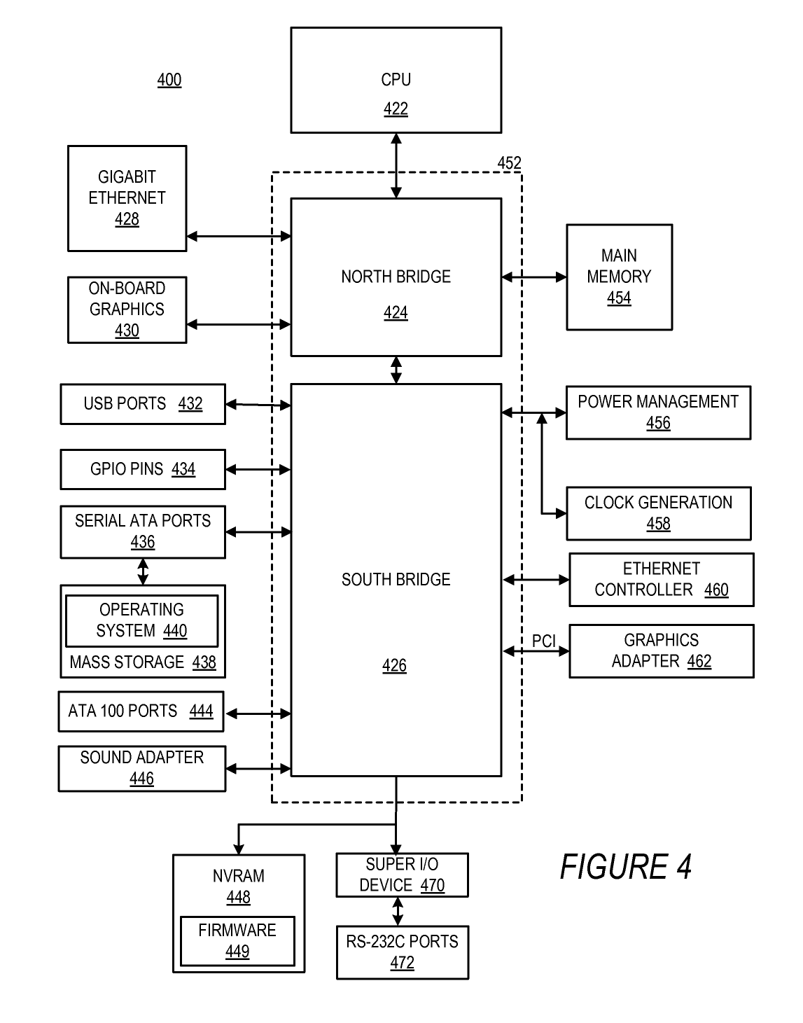

FIG. 4 shows an illustrative computer architecture for a computer 400 that may be utilized in the implementations described herein. The architecture shown in FIG. 4, or a modified version thereof, may be utilized to embody the mobile device 110 or the host device 160 shown in FIG. 1 and described above.

The computer 400 includes a baseboard, or “motherboard”, which is a printed circuit board to which a multitude of components or devices may be connected by way of a system bus or other electrical communication path. In one illustrative embodiment, a CPU 422 operates in conjunction with a chipset 452. The CPU 422 is a standard central processor that performs arithmetic and logical operations necessary for the operation of the computer. The computer 400 may include a multitude of CPUs 422.

The chipset 452 includes a north bridge 424 and a south bridge 426. The north bridge 424 provides an interface between the CPU 422 and the remainder of the computer 400. The north bridge 424 also provides an interface to a random access memory (“RAM”) used as the main memory 454 in the computer 400 and, possibly, to an on-board graphics adapter 430. The north bridge 424 may also include functionality for providing networking functionality through a gigabit Ethernet adapter 428. The gigabit Ethernet adapter 428 is capable of connecting the computer 400 to another computer via a network. Connections which may be made by the network adapter 428 may include LAN or WAN connections. LAN and WAN networking environments are commonplace in offices, enterprise-wide computer networks, intranets, and the internet. The north bridge 424 is connected to the south bridge 426.

The south bridge 426 is responsible for controlling many of the input/output functions of the computer 400. In particular, the south bridge 426 may provide one or more universal serial bus (“USB”) ports 432, a sound adapter 446, an Ethernet controller 460, and one or more general purpose input/output (“GPIO”) pins 434. The south bridge 426 may also provide a bus for interfacing peripheral card devices such as a graphics adapter 462. In one embodiment, the bus comprises a peripheral component interconnect (“PCI”) bus, but other types of busses may be utilized.

The south bridge 426 is also operative to provide one or more interfaces for connecting mass storage devices to the computer 400. For instance, according to an embodiment, the south bridge 426 includes a serial advanced technology attachment (“SATA”) adapter for providing one or more serial ATA ports 436 and an ATA 100 adapter for providing one or more ATA 100 ports 444. The serial ATA ports 436 and the ATA 100 ports 444 may be, in turn, connected to one or more mass storage devices 438 storing an operating system 440 and application programs. As discussed above, an operating system 440 comprises a set of programs that control operations of a computer and allocation of resources. An application program is software that runs on top of the operating system software, or other runtime environment, and uses computer resources to perform application specific tasks desired by the user. As also discussed above, the computer 400 may be configured in the manner described above to support external displays and interaction environments for mobile devices.

The mass storage devices connected to the south bridge 426, and their associated computer-readable storage media, provide non-volatile storage for the computer 400. Although the description of computer-readable storage media contained herein refers to a mass storage device, such as a hard disk or CD-ROM drive, it should be appreciated by those skilled in the art that computer-readable storage media can be any available media that can be accessed by the computer 400.

Computer-readable storage media includes volatile and non-volatile, removable and non-removable media implemented in any method or technology for storage of information such as computer-readable instructions, data structures, program modules or other data. For instance, computer-readable media includes, but is not limited to, RAM, ROM, EPROM, EEPROM, flash memory or other solid state memory technology, CD-ROM, DVD, HD-DVD, BLU-RAY, or other optical storage, magnetic cassettes, magnetic tape, magnetic disk storage or other magnetic storage devices, or any other medium which can be used to store the desired information and which can be accessed by the computer. The term computer-readable storage media as utilized herein does not encompass transitory signals.

A low pin count (“LPC”) interface may also be provided by the south bridge 426 for connecting a “Super I/O” device 470. The Super I/O device 470 is responsible for providing a number of input/output ports, including a keyboard port, a mouse port, a serial interface 472, a parallel port, and other types of input/output ports. The LPC interface may also connect a computer storage media such as a ROM or a flash memory such as a NVRAM 448 for storing the firmware 449 that includes program code containing the basic routines that help to start up the computer 400 and to transfer information between elements within the computer 400.

The computer 400 may be implemented as a conventional computer system, an embedded control computer, a laptop, or a server computer, a mobile device, a set-top box, a kiosk, a vehicular information system, a mobile telephone, a customized machine, or other hardware platform. The CPU 422 may be a general purpose processor, a processor core, a multiprocessor, a multi-core processor, a graphics processor, a digital signal processing (“DSP”) processor, a customized computing device implemented within an application specific integrated circuit (“ASIC”), a customized computing device implemented within a field programmable gate array (“FPGA”), a customized computing device implemented within any type of programmable logic, a state machine, a reconfigurable processor, any other processing unit, or any combination or multiplicity thereof.

The storage media may be associated with the mass storage 438. The storage media may include one or more program modules such as the display agent 130, the communication agent 140, or the host module 170. Additional program modules may support the instant-on functionality associated with, or integrated into, the firmware 449. The program modules may include software instructions that, when loaded into the CPU 422 and executed, transform a general-purpose computing system into a special-purpose computing system customized to facilitate all, or part of, the scaled display and interaction environments for mobile devices as disclosed herein. As detailed throughout this description, the program modules may provide various tools or techniques by which the computer 400 may participate within the overall systems or operating environments using the components, logic flows, and/or data structures discussed herein.

The CPU 422 may be constructed from any number of transistors or other circuit elements, which may individually or collectively assume any number of states. More specifically, the CPU 422 may operate as a state machine or finite-state machine. Such a machine may be transformed to a second machine, or specific machine by loading executable instructions contained within the program modules. These computer-executable instructions may transform the CPU 422 by specifying how the CPU 422 transitions between states, thereby transforming the transistors or other circuit elements constituting the CPU 422 from a first machine to a second machine, wherein the second machine may be specifically configured to support scaled displays and interaction environments for mobile devices. The states of either machine may also be transformed by receiving input from one or more user input devices, network interfaces 460, 428, other peripherals, other interfaces, or one or more users or other actors. Either machine may also transform states, or various physical characteristics of various output devices such as printers, speakers, video displays, or otherwise.

Encoding the program modules may also transform the physical structure of the storage media. The specific transformation of physical structure may depend on various factors, in different implementations of this description. Examples of such factors may include, but are not limited to: the technology used to implement the storage media, whether the storage media are characterized as primary or secondary storage, and the like. For example, if the storage media are implemented as semiconductor-based memory, the program modules may transform the physical state of the semiconductor memory 454 when the software is encoded therein. For example, the software may transform the state of transistors, capacitors, or other discrete circuit elements constituting the semiconductor memory.

As another example, the storage media may be implemented using magnetic or optical technology such as hard drives or optical drives. In such implementations, the program modules may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. It should be appreciated that various other transformations of physical media are possible without departing from the scope and spirit of the present description.

It should be appreciated that the computer 400 may comprise other types of computing devices, including hand-held computers, netbooks, MIDs, embedded computer systems, personal digital assistants, and other types of computing devices known to those skilled in the art. It is also contemplated that the computer 400 may not include all of the components shown in FIG. 4, may include other components that are not explicitly shown in FIG. 4, or may utilize an architecture completely different than that shown in FIG. 4.

Based on the foregoing, it should be appreciated that technologies for utilizing external displays and user input devices with mobile devices are provided herein. Although the subject matter presented herein has been described in language specific to computer structural features, methodological and transformative acts, specific computing machinery, and computer readable media, it is to be understood that the disclosure presented herein is not necessarily limited to the specific features, acts, or media described herein. The subject matter described above is provided by way of illustration only and should not be construed as limiting. Various modifications and changes may be made to the subject matter described herein without following the example embodiments and applications illustrated and described, and without departing from the true spirit and scope of the disclosure presented herein.

What is claimed is:

1. A computer-implemented method for utilizing an external display and user input devices with a mobile device, the method comprising performing computer-implemented operations for:
executing a display agent on a mobile device, the display agent configured to expose a virtual display device to a program executing on the device;
receiving display data at the display agent, the display data written to the virtual display device by the program;
providing the display data to a communications agent; and
transmitting the display data to a host module executing on a host device, the host device being configured to show the display data on an external display.

2. The computer-implemented method of claim 1, wherein the virtual display device has a higher resolution than a mobile device display integrated with the mobile device.

3. The computer-implemented method of claim 2, further comprising receiving user input at the communications agent and utilizing the user input to control the mobile device, the user input being made by way of a user input device connected to the host device.

4. The computer-implemented method of claim 3, further comprising compressing the display data prior to transmitting the display data to the host device.

5. The computer-implemented method of claim 3, further comprising scaling the display data prior to transmitting the display data to the host device.

6. The computer-implemented method of claim 3, further comprising receiving parameters from the host device and utilizing the parameters to configure operation of the mobile device.

7. The computer-implemented method of claim 6, further comprising providing a data path for signaling between the mobile device and the host device.

8. The computer-implemented method of claim 7, wherein the data path is further configured for providing notification messages between the mobile device and the host device.

9. The computer-implemented method of claim 8, further comprising displaying the notifications on the external display.

10. A computer-readable storage medium having computer-executable instructions stored thereupon which, when executed by a computer, cause the computer to:
execute a display agent on a mobile device, the display agent configured to expose a virtual display device to a program executing on the device;
receive display data at the display agent, the display data written to the virtual display device by the program;
provide the display data to a communications agent; and to
transmit the display data to a host module executing on a host device, the host device being configured to show the display data on an external display.

11. The computer-readable storage medium of claim 10, wherein the virtual display device has a higher resolution than a mobile device display integrated with the mobile device.

12. The computer-readable storage medium of claim 10, having further computer readable instructions stored thereupon which, when executed by the computer, cause the computer to receive user input at the communications agent and to utilize the user input to control the mobile device, the user input being made by way of a user input device connected to the host device.

13. The computer-readable storage medium of claim 12, having further computer readable instructions stored thereupon which, when executed by the computer, cause the computer to compress the display data prior to transmitting the display data to the host device.

14. The computer-readable storage medium of claim 13, having further computer readable instructions stored thereupon which, when executed by the computer, cause the computer to scale the display data prior to transmitting the display data to the host device.

15. A system comprising:
a mobile device configured to execute a display agent for exposing a virtual display device, to receive display data at the display agent written to the virtual display device by a program, to provide the display data to a communications agent, and to transmit the display data to a host module executing on a host device; and
a host device configured to execute a host module that receives the display data and causes the display data to be displayed on an external display connected to the host device.

16. The system of claim 15, wherein the host device is further configured to receive user input by way of a user input device connected to the host device and to transmit the user input to the mobile device.

17. The system of claim 16, wherein the mobile device is further configured to receive the user input from the host device and to execute the user input at the mobile device.

18. The system of claim 17, wherein the virtual display device has a higher resolution than a mobile device display integrated with the mobile device.

19. The system of claim 18, wherein the mobile device is further configured to scale the display data prior to transmitting the display data to the host device.

20. The system of claim 19, wherein the mobile device is further configured to compress the display data prior to transmitting the display data to the host device.
